(19) United States
(12) Patent Application Publication
(10) Pub. No.: US 2013/0162986 A1
(43) Pub. Date: Jun. 27, 2013

(54) DEVICE AND METHOD FOR DETECTION OF DEFECTS IN VITREOUS BODIES

(71) Applicants: Paul-Gerhard Kibat, Frankfurt am Main (DE); Matthias Scharf, Frankfurt am Main (DE); Hanno Juhnke, Frankfurt (DE); Rainer Bernhardt, Frankfurt am Main (DE); Jan-Peter Spengler, Frankfurt (DE); Michael Schrack, Pliezhausen (DE); Jasmin Groeschke, Frankfurt am Main (DE)

(72) Inventors: Paul-Gerhard Kibat, Frankfurt am Main (DE); Matthias Scharf, Frankfurt am Main (DE); Hanno Juhnke, Frankfurt (DE); Rainer Bernhardt, Frankfurt am Main (DE); Jan-Peter Spengler, Frankfurt (DE); Michael Schrack, Pliezhausen (DE); Jasmin Groeschke, Frankfurt am Main (DE)

(73) Assignee: SANOFI-AVENTIS DEUTSCHLAND GMBH, Frankfurt am Main (DE)

(21) Appl. No.: 13/695,164

(22) PCT Filed: May 3, 2011
(86) PCT No.: PCT/EP2011/056996

§ 371 Date: Mar. 5, 2013

(30) Foreign Application Priority Data
May 4, 2010 (EP) 10161822.1

(51) Int. Cl. G01N 21/90; G01N 21/88

(52) U.S. Cl. CPC G01N 21/90; G01N 21/8803
USPC 356/239.4

(57) ABSTRACT

The invention relates to a device for detection of glass container defects comprising a cold light source for emitting a light spectrum with limited infrared portion and optical means for directing the cold light through one or more glass containers to be observed.

### CROSS REFERENCE TO RELATED APPLICATIONS

The present application is a U.S. National Phase Application pursuant to 35 U.S.C. §371 of International Application No. PCT/EP2011/056996 filed May 3, 2011, which claims priority to European Patent Application No. 10161822.1 filed on May 4, 2010. The entire disclosure contents of these applications are herewith incorporated by reference into the present application.

### FIELD OF INVENTION

The invention is related to a device and to a corresponding method for detecting defects in vitreous bodies. In particular the invention relates to the detection of defects, like cracks and/or scratches in glass cartridges intended for storing medicinal products.

### BACKGROUND

Known devices and methods for detection of defects in cylindrical glass containers such as glass cartridge make use of a light table onto which a mass tray with multiple glass cartridges is placed. Such tray is placed upside down to observe the bottom areas of the glass cartridges due to the fact that crack occurrence in such area is most likely to occur. To detect defects, light is emitted from the light table below the glass cartridges and penetrates each glass cartridge from its top to its bottom.

In FIG. 3, a scheme of a known device is shown. There, a conventional light source 24 is located directly below the glass cartridge 100. An operator locates his head above the glass cartridge 100 to observe its bottom where most likely defects occur. A view line 70 of the operator therefore extends along the longitudinal axis of the glass cartridge 100. The light source emits light beams 22 which propagate through the glass cartridge 100 from below. Therefore, a light line 60 extends along the longitudinal axis of the glass cartridge. The light line 60 and the view line 70 are parallel and thus the detection angle 80 is 0° or 180°, respectively.

One of the problems of such known devices is the fact that cracks outside the bottom area of the glass cartridge are not detectable. Also scratches in the surface of the glass cartridge are not or at least hardly detectable. In such cases when a defect of the glass cartridge is not detected, serious problems may arise. Besides possible breakage, in particular during a subsequent filling and/or transportation of the glass cartridge, such defect could form a leak in the glass cartridge. In particular in the use of glass cartridges for medical fluids such as insulin, such leakage through a defect in the glass cartridge could lead to underdosage of the medical fluid contained in the glass cartridge. Moreover, in mass production filling and packaging processes a single broken glass cartridge may contaminate neighbouring cartridges and the environment.

A further disadvantage of such devices is the fact that the operator has to look permanently into the light incident on the cartridges, which stresses his eyes and thus reduces the detectability of glass defects over time.

It is an object of the present invention to provide an improved device and a respective method for visually inspecting glass cartridges. Defects should be easily and unambiguously detectable. Moreover, the handling and operation of the device should be less fatiguing for an operator.

### SUMMARY

The present problem is solved by a device comprising the features of independent claim 1 as well as by a method comprising the features of independent claim 10. Preferred embodiments are specified by dependent claims, respectively.

An inventive device for detection of defects in vitreous bodies, preferably in cylindrical glass containers such as glass cartridges, comprises a cold light source for emitting a cold light and optical means for directing the cold light through one or more vitreous bodies to be observed. A view line for detecting the glass container defects and a light line resulting from the direction of the cold light by the optical means include a detection angle which is less than 180°, but preferably larger than 60°.

The device further comprises variation means for the variation of the detection angle by modifying the direction of the cold light, hence the direction of the light line, hence the direction of the incident light. The variation means therefore interact with the optical means to modify the direction of the light line.

The cold light source emits a light spectrum with limited infrared portion. Cold light is an emitted light spectrum with a limited infrared portion. The expression “limited infrared portion” in the meaning of the present invention comprises both, a spectrum with significant reduction of the infrared portion as well as a spectrum which lacks the infrared portion. The significant reduction is an infrared portion. Cold light may also be defined as a light emitted at low temperatures from a source that is not incandescent, such as from a fluorescent, phosphorescent, bioluminescent, or triboluminescent light source.

Alternatively, the infrared portion of light emitted by an incandescent light source is filtered off The cold light may be further described by the Color Rendering Index (CRI), a measure of the quality of color light, devised by the International Commission on Illumination (CIE), and by the color temperature. An example of a cold light has a CRI of 90 to 100, and/or a color temperature of 5000 to 7000K.

The expression “view line” is to be understood as the line of sight of an operator or an optical inspection device such as a camera observing the glass containers for possible defects. Usually, the view line extends substantially parallel to the longitudinal axis of the glass container.

In the present context, the expression “light line” is to be understood as the general direction of the cold light as it is directed by and emanating from the optical means. For example, by using mirrors and/or lenses and/or fibre-optics as optical means, the light line is defined by the direction of the light beam given by such mirrors and/or lenses. Irrespective on whether the light is provided by fibre optical means, which may be bended or at least curved in sections, the light line defines the free propagating cold light emanating from the optical and/or variation means prior to impinge on an outer surface portion of the vitreous body.

Typically, the view line extends parallel to a longitudinal axis of an elongated vitreous body, like a cylindrical glass container or cartridge. The variation means are typically adapted and designed to modify the direction of the light line of the cold light, such that a detection angle between the view line and the light line is larger than 60° and smaller than 180°.

According to a preferred aspect, the variation means is adapted to vary the detection angle between 120° and 60°. It may even be of further benefit when the detection angle varies between 105° and 75°.

In further preferred embodiments the vitreous body comprises a cylindrically shaped container wherein the view line extends substantially parallel to the axial direction of the body. It is then of particular benefit when the cold light is incident only at a side wall section of the vitreous body, and that the view line extends in axial direction through the center of a bottom section of the vitreous body. This way, only light scattered at side wall- or bottom wall defects or cracks may propagate along the view line, thus reducing the amount and intensity of light to be detected and analysed either manually or by way of a detector-based analysing system.

The device preferably operates in transmission but not in reflection geometry, wherein with cylindrically shaped vitreous bodies, incident light propagates in radial direction or wherein only light scattered or reflected by defects, scratches or cracks of the vitreous body is exclusively detected along a central axially extending axis, or view line.

Due to the detection angle below 180°, which is defined by the light line and the view line, the cold light enters the one or more vitreous bodies, e.g. glass cartridges through their side walls, namely the walls extending along the longitudinal axis of the glass cartridges. In one setting, the detection angle could be configured to be about 90° in the starting position prior to a variation of the detection angle by the variation means. It has to be noted that the variation means can be operable by an operator by hand or can be automatically driven. They can for instance be controlled by a control system or by a computer. Depending on the construction of the variation means, the variation of the detection angle can take place in a specific range.

Said specific range can ensure that no angle is chosen at which the detection would fail or would deliver false results. Therefore, by the limiting the variation of the detection angle, in particular by limiting the angle of incidence of the incident cold light, the reliability of the system as to false detections of defects can be increased. Moreover, it is noteworthy that the variation means vary the detection angle by the variation of the direction of the light line, hence the direction of the incident cold light. This way, cost-efficient elements like mirrors and/or lenses for example can be used as an alternative to vary the position of the one or more glass cartridges and to vary the detection angle. The variation means can be located according to the needs of a specific system. Therefore, a location for varying the whole cold light source is possible as well as a location of the variation means within or after the optical means.

In an embodiment of the present invention, at the device the detection angle can be varied by the variation means between 180° and 60°, preferably between 120° and 60°, more preferred between 105° and 75°. Variation of the detection angle helps the operator of an inventive device to ensure fast and also reliable detection and observation of potential and/or existing defects. That way, the variation of the detection angle is limited to the technical meaningful range and thus avoids to spent time on observing at other detection angles.

Moreover, the limitation of the variation means can result in cheaper construction of the variation means be keeping the quality of the detection high at the same time.

Also, an inventive device can further comprise a handling means for handling the at least one vitreous bodies, like glass containers. The handling means facilitates an easy handling of the glass containers. Such handling means could also be used for handling the glass containers outside and independent of the inventive device.

By using a handling means, the device and the handling means can be adapted to each other to form respective interfaces. The interface between the handling means and the device, in particular the variation means and the optical means is independent from the form or sort of the vitreous body. For observing different glass containers within one single inventive device, in a cost-efficient way, only different handling means can be used to ensure one single interface to the device. Moreover, by using alternative handling means, in particular handling means which allow the penetration of cold light from their sides to the glass containers, also already existing devices, as described above as to known devices, can be updated, hence retrofitted to become an inventive device. Such a handling device is configured to be penetrated by cold light from its side to the side of the glass containers. In particular, a side wall section of the handling device, like a tray for instance, has to be penetrable by cold light. This could for example be solved by a window or a respective through opening, open for cold light.

According to one aspect of the present invention, at an inventive device the handling means is a mass tray for multiple glass containers or a top cover for placing the multiple containers upside down in the z direction for inspection from the bottom. For the demand of observing multiple vitreous bodies within short time, such mass trays as handling means can be meaningful. The expression “multiple” is to be understood as two or more glass containers. The containers can be ordered within such mass tray in matrix organisation such that each glass container can be identified by its line and column. That way, beside optical observation by an operator, also automatical observation is possible, individually indicating line and column of detected glass containers with defects. In a following step, an operator can remove the indicated glass containers from the mass tray before the next procedural step takes place.

Alternatively, at an inventive device the handling means comprise rotating elements for rotating a glass container around an axis defined by the view line. As an alternative to the use of a mass tray, also handling means for single glass containers can be used. That way, also more complex handling of the vitreous bodies or glass containers within the device can be performed. For example, the use of a handling means comprising rotating elements can fix the vitreous bodies to the rotating elements to rotate the glass container around its longitudinal axis, hence, around the view line. Such rotation helps to observe the whole body of the glass container, including its overall or side surface.

At an inventive device the variation means may be configured to result or to provide a detection angle of 90° in a starting configuration of the device. To ensure that an inventive device has a defined starting position, the variation means can be configured to provide a detection angle of 90° in a starting configuration. That way, an operator can be sure that the inventive device always starts the observation from the same starting point. Any step for resetting the device becomes obsolete. Then, variation of the detection angle always starts from the same detection angle. This can for example be achieved by spring means or other force applying restoring elements to return or to move the variation means into a defined position if no outer force is applied.

According to another aspect of the present invention, an inventive device can be constructed such that the variation means comprises at least one mirror and/or at least one lens. The use of different optical means is also possible. The variation means can also be a collection of different or similar optical elements. For example, a combination of lenses and mirrors or a combination of different lenses resulting in a lens system may provide a variation means. Also, the use of fibre-optic components for directing the light from the cold light source is possible. Besides for the variation means, the same optical elements, namely lenses, mirrors and fibre-optics, and in general, refractive and diffractive beam shaping elements of all types can be used for and as the optical means.

Moreover, at an inventive device the variation means can comprise two rotating mirrors. By using such an inventive device for the detection of defects at single glass containers, such glass containers can be rotated by hand or automatically by handling means. Such rotation, in particular if carried out automatically, can be correlated with the rotation of the mirrors. That way, the whole glass container can be observed according to the rotation of the glass container over all possible detection angles according to the rotation of the mirrors. The correlation of both rotational movements can either be carried out manually by hand or automatically by a computer or a mechanical gear box. That way, defects can be detected at the glass containers located all over its surface and or at all positions within the vitreous body. In particular, cracks at the shoulder area as well as cracks in the bottom area can be detected.

One further aspect of the present invention is a method for carrying out a detection of defects of a vitreous body, in particular of a glass container, comprising the following steps:

emitting cold light with a light spectrum with limited infrared portion and directing the light to at least one vitreous body along a light line,

detecting defects of the vitreous body along a view line extending substantially in a longitudinal direction of the vitreous body, wherein a detection angle between the view line and the light line is larger than 60° and smaller than 180°, and

varying the detection angle by the variation of the direction of the cold light, or the corresponding light line, respectively.

This method implements a visual examination of vitreous bodies, and in particular of cylindrically shaped bodies, by way of transmissive illumination. Here, a light beam is incident on the inspection object in radial inwardly pointing direction and only a portion of the incident light scattered or otherwise reflected from defects of the vitreous body are observed along a view line, substantially extending in axial direction of the vitreous body. This way, the amount and intensity of light propagating along the view line can be remarkably reduced, thus making it easier for an operator or for an automated detection system to detect and to identify defects of the body.

Making further use of cold light allows to increase the intensity of the light without increasing thermal radiation and heat emitted by the light source. The increase of the light intensity and surprisingly the use of cold light in general for detecting defects in glass containers also results in an increased contrast of the diffused or scattered light caused by the defects to be detected. That way such defects are more easily to be detected visually.

The method according to the invention can be carried out with a device according to the description above. Typically, the method is to be carried out in a mass production or mass manufacturing environment, especially for detecting defects in cylindrical glass containers, such like carpules, cartridges or bottles adapted to be filled with a liquid medicament.

In a further aspect, the vitreous body is visually inspected in transmission geometry, with the cold light being incident on the body's circumferential side wall section at a substantially perpendicular angle of incidence. Typically, the incident light propagates parallel to a radially outwardly directed surface normal of the side wall section of the cylindrical body. Then, in the course of the visual inspection procedure, the angle of incidence can be modified toward an axial direction, such that the detection angle ranges between 75° to 105°, or between 60° and 120°, respectively. Here, an inspection plane, defined by the direction of incident light and the view line extends in radial and axial direction of the cylindrical body.

According to a further aspect of the inventive method, in an additional step one or more vitreous bodies comprising at least one defect are indicated for a selection thereof. Such indication could for example be carried out automatically by extracting or separating the defect vitreous body from a handling means, like a mass tray. Also, an indication by colour-coding or by defining the location of a defect glass cartridge within a handling means is possible. If an operator is observing visually, he can indicate the defect glass containers and may manually separate them from a further processing of the glass containers.

### BRIEF DESCRIPTION OF THE DRAWINGS

The invention is described in more detail with respect to the figures. Such figures show:

FIG. 1 is an isometric view of a first embodiment of an inventive device

FIG. 2 is an isometric view of a second embodiment of an inventive device

FIG. 3 is an isometric view of a known device according to the prior art,

FIG. 4a is an isometric view of a third embodiment of an inventive device

FIG. 4b is the embodiment of FIG. 4a with a varied detection angle

FIG. 4c is the embodiment of FIG. 4a with a further varied detection angle

### DETAILED DESCRIPTION

The invention is further outlined in the following examples, wherein the glass container is a glass cartridge.

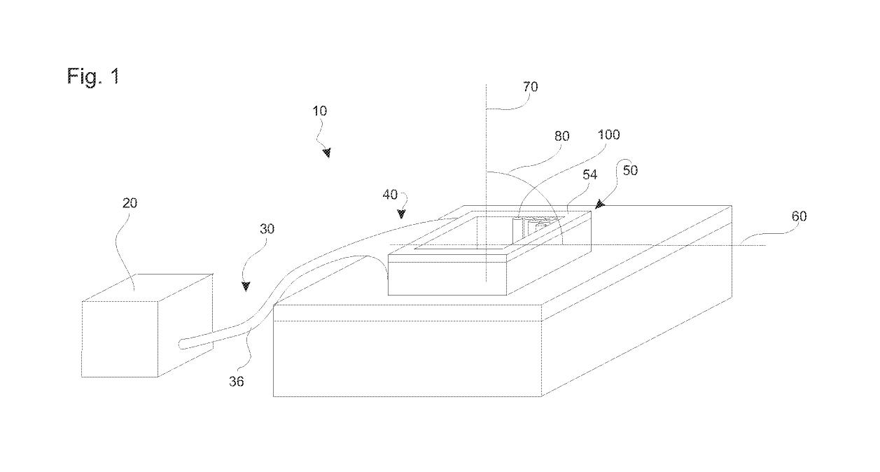

In FIG. 1, a first embodiment of the present invention is shown. Here, the device 10 comprises a cold light source 20, shown on the left side of FIG. 1. The light source 20 typically comprises a Halogen or Xenon lamp located in an elliptic reflector. The reflector itself is coated such that the infrared portion of the light generated by the lamp is not reflected. Only non-infrared portions of the light are reflected and thus are able to emanate from the cold light source 20. The light source 20 has an opening which is in connection with an optical means 30. Such optical means 30 comprises a fibre-optic 36 covered by a non-transparent, in particular a inside-reflecting coversheet or cladding. The optical fibre 36 is used to direct the cold light, emitted by the cold light source 20 to glass cartridges 100 for detection of defects. In unity with the optical means 30, variation means 40 are located at the end of the fibre-optic opposite to the connection to the cold light source 20. The variation means 40 are comprised also within the cover and can be operated automatically from outside the cover. The variation takes place by the use of a system of lenses and mirrors inside the cover which are manipulated by actuation means such as mechanical gears or small electric motors. Also, the direction of the outlet end of the fibre can be modified.

The device 10 further comprises a table on which a handling means 50 is placed. Such table can for example be an already existing conventional light table, which is retrofitted with the cold light source for improved detection of defects. The handling means 50 of this embodiment is a mass tray 54. Such mass tray 54 defines a transport volume adapted to receive and to hold multiple glass cartridges 100. The mass tray 54 can also be used as a handling means 50 outside the device 10, for example to transport the produced glass cartridges 100 to the device 10 and/or to transport the inspected glass cartridges 100 to a subsequent procedural step in a mass manufacturing environment.

In FIG. 1 two lines are indicated, namely the view line 70 as well as the light line 60. The view line 70 is extending perpendicular out of the opening of the mass tray 54. This line defines the line for observation of the glass cartridges 100. An operator, who stands in front of the table and can place his head over the mass tray 54 and can look down along the view line 70.

The cold light enters the mass tray 54 from the left side by leaving the optical means 30. In FIG. 1 a starting configuration is shown at which the cold light enters the mass tray 54 perpendicular to the view line 70. Therefore, the light line 60, as shown in FIG. 1, is also perpendicular to the view line 70. The detection angle included between the view line 70 and the light line 60 is therefore substantially 90°.

By using the variation means 40, the direction of the cold light can be varied. Based on such variation, the direction of the light line 60 and the detection angle 80 change. The view line 70 remains uninfluenced by the variation of the detection angle 80. Therefore, an operator does not need to change his position during the observation of the glass cartridges 100.

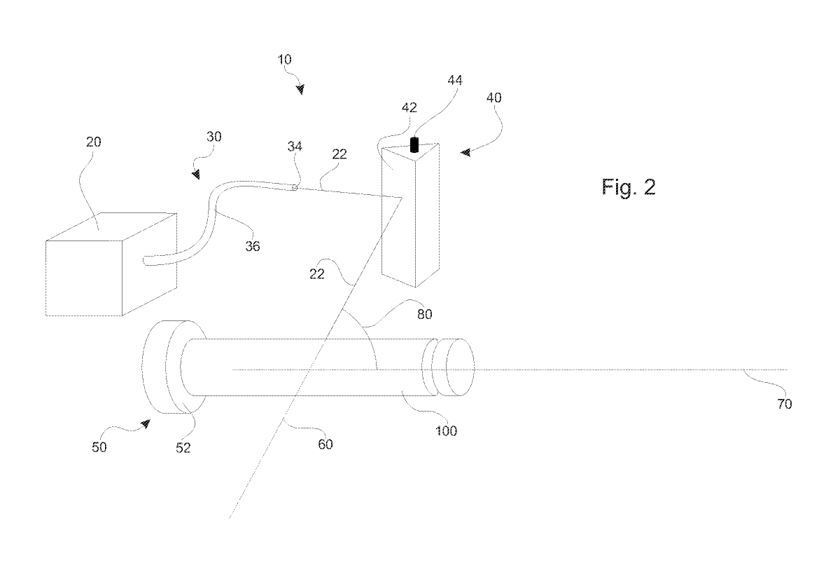

FIG. 2 shows a different embodiment of the inventive device 10, wherein reference numerals already used in FIG. 1 depict identical components. Once more, a cold light source 20, is located at the left side of device 10. Also here, an optical means 30 is connected to the light source 20. This optical means 30 comprises a flexible optical fibre for directing the cold light to the place of observation of glass cartridges 100. According to this embodiment, the variation means 40 is totally separated from the optical means 30. The variation means is constructed as a mirror 42 of generally triangular profile. The mirror 42 is rotatable around an axis 44 which also fixes the mirror 42 with respect to the device 10.

The mirror 42 can comprise different surface structures on its three outer surfaces. According to the different structures, the light line 60 or the light itself can be influenced by changing the surface structure of the variation means 40.

The variation means is 40 are preferably adapted to vary the detection angle 80. In this embodiment, the cold light beam leaves the fibre-optic 36 through a lens 34 and defines by the path of the cold light beam 22 the light line 60. The cold light beam 22 as well as the light line 60 are reflected by mirror 42 according to its rotational status with respect the mirror axis 44. Therefore, in this embodiment, the light line 60 comprises a bend created by the mirror 42.

Following the cold light beam 22 and the light line 60, the cold light is incident on and penetrates a glass cartridge 100. The glass cartridge 100 is located within a handling means 50 to be handled within device 10. The handling means 50 comprise a rotating element 52, to which the glass cartridge 100 can be fixed for inspection purpose. Therefore, the glass cartridge 100 is rotatable within the device 10. The handling means is preferably adapted to rotate the glass cartridge around its longitudinal or long axis extending parallel to the axial direction of the cartridge 100. As illustrated, the longitudinal axis, the axis of rotation and the view line 70 substantially overlap.

Defined by the longitudinal axis of the glass cartridge 100 is the view line 70. At the right end of view line 70 according to FIG. 2, an operator can place his head, in particular his eye to observe the glass cartridge 100 to detect potential defects.

Also here, the view line 70 remains at its location and is rather static while the detection angle 80 is varied and/or while glass cartridge 100 is rotated. Therefore, the operator does not need to move during the observation process. Also, an automatical observation is easily implementable due to the static position or due to the remaining of the view line 70.

By rotation of mirror 42, the reflection of the cold light beam 22 is varied and the therefore, the light line 60 can be changed accordingly. In particular, it can be turned around the mirror axis 44. Following that turn of the light line 60, also the detection angle included between the light line 60 and the view line 70 is increased or decreased, depending on the direction of the rotation of the mirror 42.

The correlation between the rotation of the mirror 42 and the rotation of the glass cartridge 100 creates the possibility of observation of the whole or entire glass cartridge 100. By the variation of the detection angle 80, the glass cartridge can be scanned longitudinally and by the rotation of the glass cartridge 100 around the longitudinal axis, it can be scanned in radial or circumferential orientation or direction. Therefore, due to this correlation, a 3-dimensional observation of the glass cartridge 100 is possible.

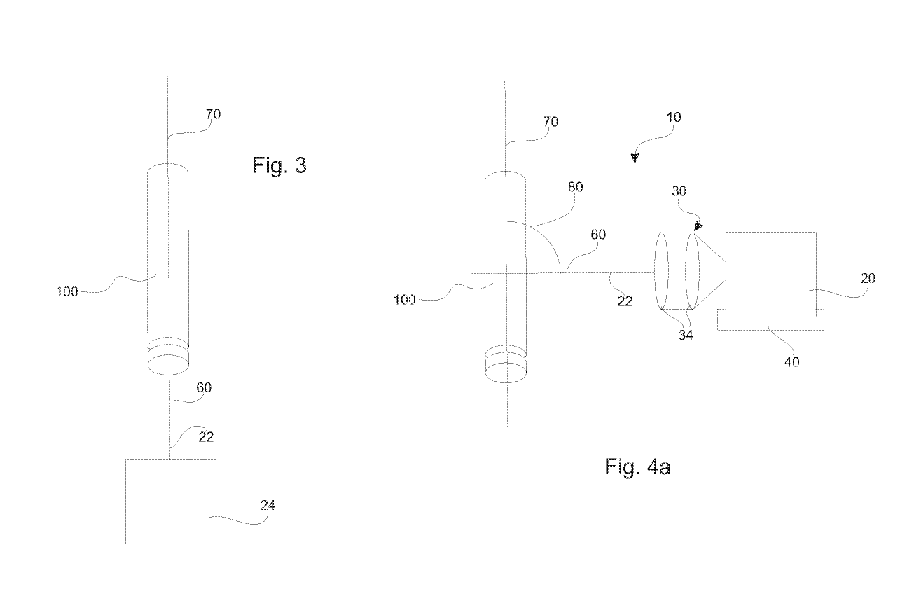

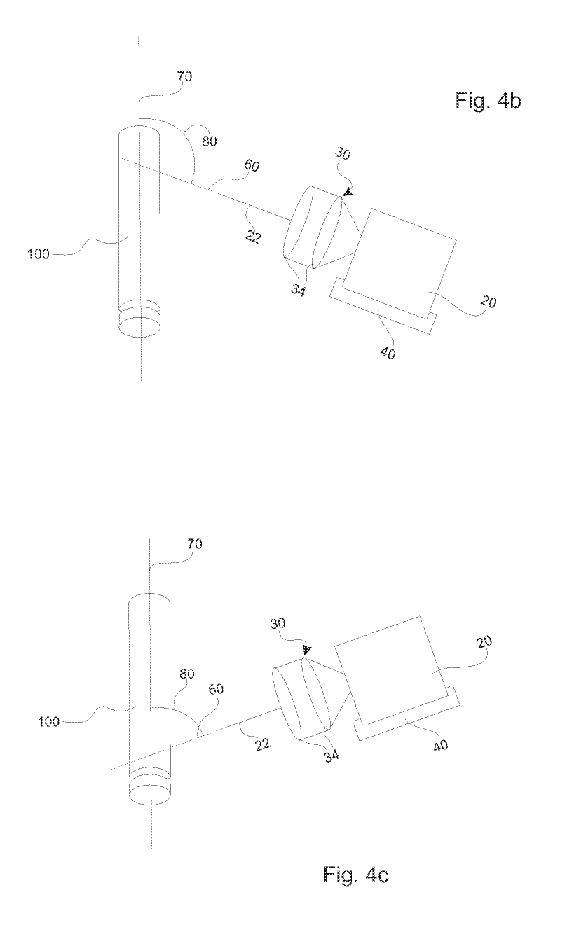

FIG. 4a shows a further embodiment of an inventive device 10. The glass cartridge 10, which is also exemplary for multiple glass cartridges 100 of the same orientation, can be penetrated and/or impinged by light from a cold light source 20. The cold light, emitted by the cold light source 20 is directed by optical means 30. Here, the optical means 30 comprise two lenses 34 for directing the cold light to the glass cartridge 100. The situation shown in FIG. 3 once more is a starting configuration of the device 10. The light line 60 and the view line 70 are perpendicular to each other, namely the detection angle 80 substantially equals 90°. Also here, the view line 70 is defined by an operator observing the glass cartridges 100 or by an automatic detections system like a camera or the like.

The variation means 40 of this embodiment is located in connection to the cold light source 20 to vary the detection angle 80 by changing the orientation of the cold light source 20. The FIGS. 4b and 4c show situations where the variation means 40 have varied the detection angle 80 into two different directions.

The variation means 40 as illustrated in FIG. 3 has a rotational axis and is rotated by an electrical motor or manually by an operator. Manual operation can be assisted by mechanical gears and drives or the like. The embodiment of FIG. 3 can also be combined with handlings means 50 of the embodiments of FIG. 1 or 2. Therefore, by using the device 10 for single glass cartridges 100, handling means 50 with rotating elements 52 of FIG. 2 can be used. For the observation of multiple glass cartridges 100, also a mass tray 54 as disclosed in FIG. 1 can be used in an embodiment according to FIG. 3.

It has to be noted that the different solutions for the construction as well as the location of the variation means 40 shown in the figures do not limit the scope claims. Moreover, the different options can be combined as to the different optical means 30 and the different handling means 50.

1-14. (canceled)

15. Device for detection of defects of a vitreous body comprising:
a cold light source for emitting a cold light;
optical means for directing the cold light to at least one vitreous body along a light line, wherein a view line for visually detecting a defect of the vitreous body extends in longitudinal direction of the vitreous body,
variation means for modifying the direction of the light line of the cold light, such that a detection angle between the view line and the light line is larger than 60° and smaller than 180°.

16. Device according to claim 15 characterised in that the variation means is adapted to vary the detection angle between 120° and 60°.

17. Device according to claim 15, wherein the variation means is adapted to vary the detection angle between 105° and 75°.

18. Device according to claim 15, wherein the vitreous body comprises a cylindrically shaped container, wherein the view line extends substantially parallel to the axial direction of the container.

19. Device according to claim 15, further comprising a handling means adapted to rotate the at least one vitreous body around an axis defined by the view line.

20. Device according to claim 19 characterised in that the handling means is a mass tray for multiple vitreous bodies.

21. Device according to claim 15, characterised in that the variation means is configured to provide a detection angle of 90° in a starting configuration.

22. Device according to claim 15, characterised in that the variation means comprises at least one mirror and/or at least one lens.

23. Device according to claim 21, characterised in that the variation means comprises two rotating mirrors.

24. Method for detecting defects in a vitreous body comprising the following steps:
directing cold light from a cold light source to at least one virtreous body along a light line,
detecting defects of the vitreous body along a view line extending substantially in longitudinal direction of the vitreous body, wherein a detection angle between the view line and the light line is larger than 60° and smaller than 180°, and
varying the detection angle by varying the direction of the light line (60).

25. The method according to claim 24 characterised in that it is carried out with a device.

26. The method according to claim 24, wherein the vitreous body comprises a cylindrical glass container and/or a cylindrical glass cartridge.

27. The method according to claim 24, wherein the cold light is incident on a side wall section of the vitreous body and wherein light scattered by defects in or on the vitreous body is detected in axial direction of the vitreous body.

28. The method according to claim 24, wherein the vitreous body (100) is inspected in transmission geometry with the cold light being incident on the body's side wall section at a substantially perpendicular angle of incidence.
